(19) United States
(12) Patent Application Publication
(10) Pub. No.: US 2004/0236578 A1
(43) Pub. Date: Nov. 25, 2004

(54) Semiconductor chip for a mobile telephone which includes a text to speech system, a method of aurally presenting a notification or text message from a mobile telephone and a mobile telephone

(76) Inventor: Paul William Shields, Livingston (GB)

Correspondence Address: OLIFF & BERRIDGE, PLC, P.O. BOX 19928, ALEXANDRIA, VA, 22320, US

(21) Appl. No.: 10/484,798

(22) PCT Filed: Jun. 12, 2003
(86) PCT No.: PCT/GB03/02544

(30) Foreign Application Priority Data
Jun. 13, 2002 (GB) 0213626.5

(51) Int. Cl. G10L 13/08

(52) U.S. Cl. 704/260

(57) ABSTRACT

A semiconductor chip for use in a mobile telephone which includes a text to speech (TTS) system, a method of aurally presenting a notification or text message from a mobile telephone and a mobile telephone Mobile telephones are increasingly being developed with additional functions. These include the ability to play music, access the internet and/or play game. When one of these functions is being operated on the mobile telephone, a user may not be aware of the indicators alerting the user to the fact that there is an incoming telephone call or text message. It is envisaged that mobile telephones could be provided with text to speech TTS systems. The text which is converted by the TTS system may be an indicator of the incoming call or text message itself. The present invention is directed towards a mobile telephone in combination with a TTS system which will alleviate the problems associated with a user not being aware of the indicators or notifications that there is an incoming call or text message. The present invention thus relates to a semiconductor chip and method of aurally presenting a notification or text message from a mobile telephone which includes a TTS system, comprising: selecting a priority of presenting said notification or text message; receiving said notification or text message; providing said notification or text message to said TTS; and aurally presenting said notification or text message.

The present invention relates to a semiconductor chip for use in a mobile telephone which includes a text to speech (TTS) system, a method of aurally presenting a notification or text message from a mobile telephone and a mobile telephone.

A mobile telephone is not only able to make telephone calls and send text messages but also can receive telephone calls and text messages. When an incoming telephone call or text message is received, the user may be given an audio alert, a mechanical vibration or notification on the screen or any combination of these indicators.

Mobile telephones are increasingly being developed with additional functions. These include the ability to play music, access the internet and/or play games. When one of these functions is being operated on the mobile telephone, a user may not be aware of the indicators alerting the user to the fact that there is an incoming telephone call or text message. This situation is particularly likely when the mobile telephone is playing music with or without headphones.

Recently, there have been significant developments in text to speech (TTS) systems in many electrical devices. A text to speech (TTS) system converts text to speech and involves determining the correct pronunciation. In addition to the correct pronunciation, many TTS systems control how the text is spoken by defining a particular speech mode. A speech mode may be defined as to at least the prosody, i.e. the speech rhythms, stresses on various words, changes in pitch, rate of speaking, changes in volume and how the text is spoken in terms of currency values, dates, times etc amongst other features.

Hitherto, such TTS systems have not been used in mobile telephones but it is envisaged that mobile telephones could be provided with TTS systems. The text which is converted by the TTS system may be an indicator of the incoming call or text message itself. The present invention is directed towards a mobile telephone in combination with a TTS system which will alleviate the problems associated with a user not being aware of the indicators or notifications that there is an incoming call or text message as discussed above.

Thus, an aim of the present invention is to provide a semiconductor chip, a method and a mobile telephone which aurally presents a notification or text message.

The present invention relates to a semiconductor chip for use in a mobile telephone which includes a text to speech (TTS) system, said chip includes:

control means for receiving a notification of an incoming call or a text message; and

a memory coupled to said control means, said memory for storing presentation priority data as to the timing and manner of the presentation of said notification or text message in which said control means is coupled to said TTS thereby enabling said TTS to aurally present said notification or said text message.

The present invention also relates to a method of aurally presenting a notification or text message from a mobile telephone which includes a TTS system, said method comprising:

selecting a priority of presenting said notification or text message;

receiving said notification or text message;

providing said notification or text message to said TTS; and

aurally presenting said notification or text message.

Finally, the present invention includes a mobile telephone including a text to speech (TTS) system coupled to a semiconductor chip as claimed in the attached claims.

Embodiments of the present invention will now be described by way of further example only and with reference to the accompanying drawings, in which:

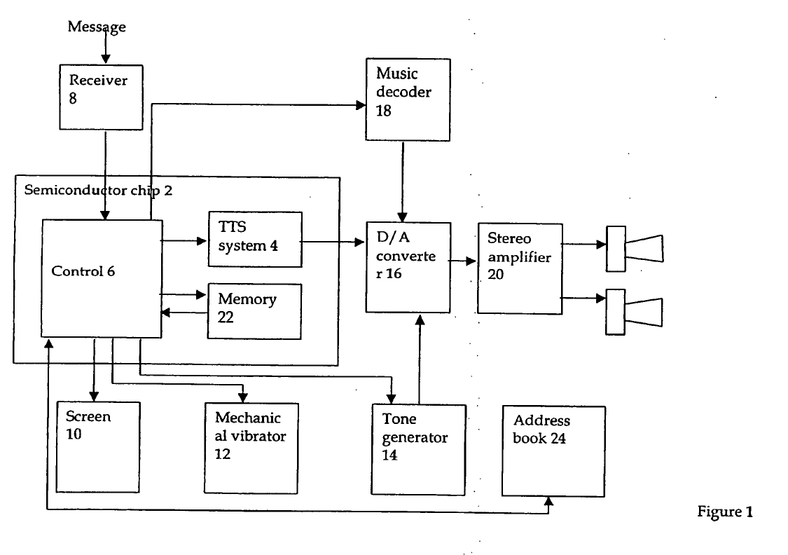

FIG. 1 is a schematic diagram of part of a mobile telephone according to the present invention;

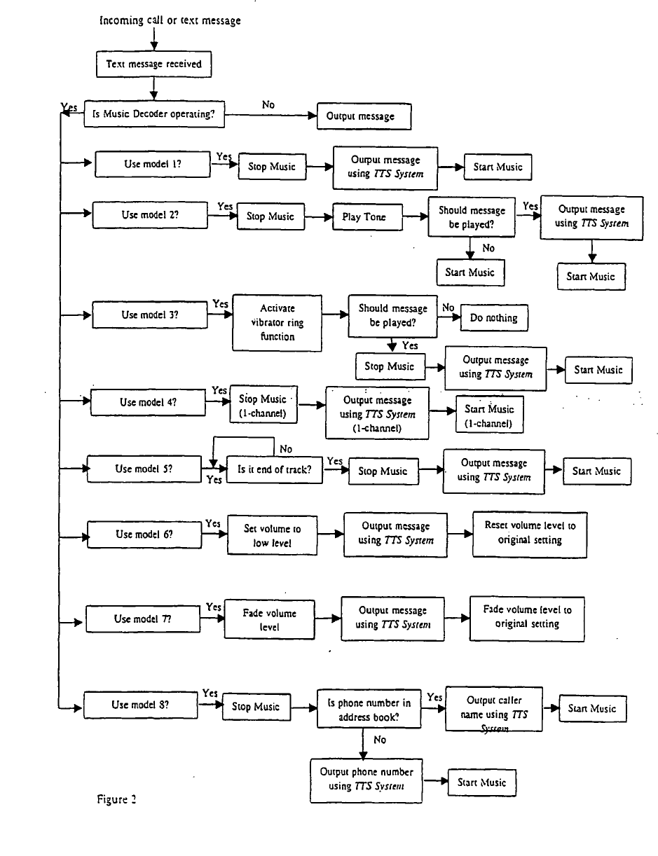

FIG. 2 is a flow diagram of a method of aurally presenting a notification or text message according to the present invention;

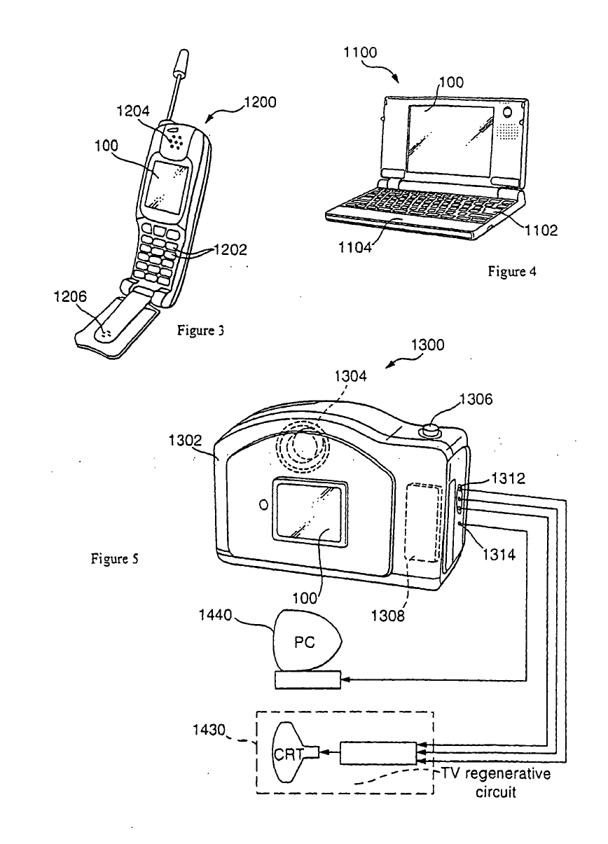

FIG. 3 is a schematic view of a mobile telephone according to the present invention;

FIG. 4 is a schematic view of a mobile personal computer according to the present invention; and

FIG. 5 is a schematic view of a digital camera according to the present invention.

FIG. 1 illustrates a semiconductor chip 2 in which a TTS system 4 is embedded. The chip 2 also includes a control 6. A receiver 8 receives the incoming call or text message, and is coupled to the control 6. The control 6 provides a notification of the incoming call or text message to the screen 10, mechanical vibrator 12 and/or tone generator 14. The control could also enable the text message to be displayed on the screen 10.

The mobile telephone includes a digital to analogue (D/A) converter 16 coupled to the semiconductor chip 2 and the tone generator 14. The mobile telephone furthermore includes a music decoder 18 which is coupled to the semiconductor chip 2 and D/A converter 16. Although in this embodiment, a music decoder is shown and described, this should also be taken to include and/or be replaced by a games decoder and/or internet decoder.

The D/A converter receives digital signals from the tone generator 14, music decoder 18 and TTS system 4 and outputs analogue signals to a stereo amplifier 20. The stereo amplifier is also coupled to the control 6 for enabling the control 6 to control the volume at which the stereo amplifier outputs the tone, music or text from the TTS system.

The mobile telephone also includes an address book 24 which is coupled to the control 6 so that the control 6 can interrogate the address book to find the name relating to the telephone number of the incoming call or text message. The control 6 can then output the name together with the notification or text message via the TTS system or by display on the screen.

In operation, the receiver 8 receives an incoming call or text message and passes the same to the control 6. The control 6 determines the timing and manner in which the user is notified of the incoming call or text message. The control may notify the user by displaying the notification or text message on the screen 10, and/or cause a vibration using the mechanical vibrator 12 and/or or initiate the tone generator 14 to output a tone. In addition, the control 6 may initiate the TTS system 4 to output the notification or text message. The tone from the tone generator, the notification or text message from the TTS system is converted by the D/A converter 16 and output by the stereo amplifier 20.

The control 6 also determines whether music is playing by interrogating the music decoder 18. The control 6 controls the timing of the notification and/or modifies the volume output by the stereo amplifier 20. In addition, when headphones or an ear piece are being used, the control 6 can control the output by the stereo amplifier to determine whether music and/or the notification is output to both left and right channels simultaneously or output music to one channel and the notification to the other channel.

The control 6 is also coupled to a memory 22 which is used to store priority data as to the timing and manner of presenting the notification.

FIG. 2 illustrates a flow diagram of the timing and manner of presentation that can be effected in accordance with the present invention. The data as to the timing and manner of presentation is collated into various models. Some of these are illustrated but those illustrated are not the only models which can be used. A user may select one of these models and that selection is stored in the memory 22.

The control 6, when receiving details of the message from the receiver 8, interrogates the music decoder 18 to determine whether music is playing. If music is not playing, then the control 6 outputs the notification and/or the message according to that predetermined by the user. In this embodiment, the text message or notification of the incoming call is output by the TTS system.

If music is playing and model 1 is selected, then the control 6 instructs the music decoder to stop the music. Contemporaneously, the control 6 directs the TTS system to output the text message or notification of the incoming call. When the text message or notification is completed, then the control 6 instructs the music decoder to start the music.

If model 2 is selected, then the control 6 instructs the music decoder to stop the music. Contemporaneously, the control 6 commands the tone generator 14 to output a tone indicating the notification of the message or incoming call. If instructed by the user, the control 6 directs the TTS system to output the text message. When the text message is completed, then the control 6 instructs the music decoder to start the music. If the user does not provide an instruction within a predetermined period of time, then the control 6 instructs the music decoder to start the music without having output the text message or receiving the incoming call.

If model 3 is selected, then the control 6, having determined that music is playing, commands the mechanical vibrator 12 to activate a vibration. If instructed by the user, then the control 6 instructs the music decoder 18 to stop the music. The control 6 directs the TTS system 14 to output the text message. When the text message is completed, then the control 6 instructs the music decoder to start the music. If the user does not provide an instruction within a predetermined period of time, then no action is taken without the text message being output or the incoming call received.

In model 2 and 3, a user may select the predetermined period of time for providing instructions and this period may be stored in the memory 22.

Moreover, in model 2 and 3, a user may provide instructions to output the text message or take the incoming call immediately, at the end of a song or track of the music or not at all.

If model 4 is selected, then the control 6, having determined that music is playing, commands the stereo amplifier 20 to stop outputting the music in one channel, either left or right. Contemporaneously, the control 6 directs the TTS system 14 to output the text message or incoming call in the other channel. When that is completed, then the control 6 instructs the music decoder to start the music in that channel.

The user may predetermine which channel is to be used to maintain the music and which channel is to be used to output the text message or incoming call and the preference may be stored in the memory 22.

In model 5, the control 6, having determined that music is playing, also determines whether the music has reached the end of the song or track. When the end of the song or track has been determined, then the control 6 instructs the music decoder 18 to stop the music. As discussed above, if the music decoder includes or is replaced by a games decoder or internet decoder, then the control 6 will determine if the end of the game is reached or paused or whether the user has finished viewing a web page and is starting to view another page.

Having stopped the music, game or internet access, the control 6 directs the TTS system to output the text message. When the text message is completed, then the control 6 instructs the music decoder to start the music, or the game decoder to start the game or the internet decoder to find the next web page.

If model 6 is selected, then the control 6, having determined that music is playing, commands the stereo amplifier to reduce the volume of the music being output to a lower level. The lower level may or may not be predetermined by the user and the lower level may be stored in the memory 22. The control 6 then directs the TTS system to output the text message. When the text message is completed, then the control 6 instructs the music decoder to resume the volume of the music.

If model 7 is selected, then the control 6, having determined that music is playing, commands the stereo amplifier to fade the volume of the music being output to zero over a first period of time. The control 6 directs the TTS system to output the text message. The control 6 may immediately direct the output of the text message or after a second period of time or after the control 6 determines from the stereo amplifier that the volume of the music is below a threshold. The user may or may not predetermine the first and second period of time and/or the threshold and this data may be stored in the memory 22. When the text message is completed, then the control 6 instructs the music decoder to resume the volume of the music.

In model 8, the control 6 instructs the music decoder to stop the music. Contemporaneously, the control 6 interrogates the address book 24 to determine if the number of the incoming call or text message is present. If the number is present, then the control 6 directs the TTS system to output the name associated with the number. If the number is not present in the address book, then the control 6 directs the TTS system to output the number. The control 6 may also direct the TTS system to output the text message. When the TTS system has completed outputting the name or number or text message is completed, then the control 6 instructs the music decoder to start the music.

The embodiment has been described with reference to a mobile telephone but the present invention is advantageous for use in any small, mobile electronic products which are capable of sending and receiving calls and text messages such as, computers, CD players, DVD players and the like—although it is not limited thereto.

Several electronic products using the present invention will now be described.

<1: Portable Phone>

FIG. 3 is an isometric view illustrating the configuration of a mobile telephone. In the drawing, the mobile telephone 1200 is provided with a plurality of operation keys 1202, an ear piece 1204, a mouthpiece 1206, and a display panel 100. The mouthpiece 1206 or ear piece 1204 may be used for outputting speech.

<2: Mobile Computer>

FIG. 4 is an isometric view illustrating the configuration of this personal computer. In the drawing, the personal computer 1100 is provided with a body 1104 including a keyboard 1102 and a display unit 1106. The present invention may use the display unit 1106 or keyboard 1102 to provide the user interface according to the present invention, as described above.

<3: Digital Still Camera>

Next, a digital still camera using the present invention will be described. FIG. 5 is an isometric view illustrating the configuration of the digital still camera and the connection to external devices in brief.

Typical cameras sensitise films based on optical images from objects, whereas the digital still camera 1300 generates imaging signals from the optical image of an object by photoelectric conversion using, for example, a charge coupled device (CCD). The digital still camera 1300 is provided with an OEL element 100 at the back face of a case 1302 to perform display based on the imaging signals from the CCD. Thus, the display panel 100 functions as a finder for displaying the object. A photo acceptance unit 1304 including optical lenses and the CCD is provided at the front side (behind in the drawing) of the case 1302. The present invention may be embodied in the digital still camera.

Further examples of electronic products, other than the mobile telephone shown in FIG. 3, the computer shown in FIG. 4, and the digital still camera shown in FIG. 5, include television sets, view-finder-type and monitoring-type video tape recorders, car navigation systems, pagers, electronic notebooks, portable calculators, word processors, workstations, TV telephones, point-of-sales system (POS) terminals, and devices provided with touch panels.

In whichever situation, the present invention enables users to be alerted to incoming calls and text messages with greater accuracy and convenience than known hitherto. That is to say incoming calls and text messages are notified and delivered more efficiently. This is particularly important when mobile telephones are being used to play music, games or access the internet or when difficult to view or access, such as being in a pocket or bag.

The foregoing description has been given by way of example only and it will be appreciated by a person skilled in the art that modifications can be made without departing from the scope of the present invention.

For example, the embodiment illustrated and shown is described with a semiconductor chip having an embedded TTS system. However, the semiconductor chip may not include the TTS system and this may be provided elsewhere in the mobile telephone.

A number of models as to the timing and presentation of the incoming call and text message have been described. It is explicitly stated that these models are not mutually exclusive. That is to say, models 3, 4, 5, 6 and 7 can be combined in any two, three or four combinations which is readily apparent to a skilled person. In addition, the interrogation of the address book described in model 8 can be combined with any other of the models or merely outputting the message via the TTS system.

1. A semiconductor chip for use in a mobile telephone which includes a text to speech (TTS) system, said chip includes:
control means for receiving a notification of an incoming call or a text message; and
a memory coupled to said control means, said memory for storing presentation priority data as to the timing and manner of the presentation of said notification or text message in which said control means is coupled to said TTS thereby enabling said TTS to aurally present said notification or said text message.

2. A method of aurally presenting a notification or text message from a mobile telephone which includes a TTS system, said method comprising:
selecting a priority of presenting said notification or text message;
receiving said notification or text message;
providing said notification or text message to said TTS; and
aurally presenting said notification or text message.

3. A method as claimed in claim 2, wherein said presentation priority includes any one of the following:
a) interrupting a current status of the mobile telephone and presenting said notification or text message;
b) presenting a predetermined alert and when instructed by a user of the mobile telephone presenting said notification or text message;
c) awaiting a change in the current status of the mobile telephone and then presenting the notification or text message; or
d) presenting said notification or text message whilst maintaining the current status of the mobile telephone.

4. A method as claimed in claim 3, wherein said predetermined alert comprises either an audio tone or a mechanical vibration.

5. A method as claimed in claim 3, wherein said maintaining the current status includes any one of the following:
a) reducing the sound volume of the current status;
b) fading to zero the sound volume of the current status; or
c) maintaining the current status in one earpiece whilst presenting said notification or text message in the other earpiece.

6. A method as claimed in claim 3, in which said current status includes the mobile telephone being used for another telephone call or being used for playing music or being used for playing a game or being used for accessing the internet.

7. A method as claimed in claim 6, in which awaiting a change in the current status includes waiting until the end of a song or track, waiting until the end of the game or a pause in the game, or waiting until a new web page is being sought.

8. A method as claimed in claim 2, further comprising after receiving said notification or text message:
interrogating an address book of the mobile telephone to determine the identity of the notification or the text message; and
aurally presenting said identity.

9. A mobile telephone including a text to speech (TTS) system coupled to a semiconductor chip as claimed in claim 1.

10. A mobile telephone as claimed in claim 9, further comprising an address book coupled to said semiconductor chip for enabling said control means to interrogate said address book to determine an identity of the incoming telephone call or sender of the text message, such that said identity is passed together with said notification or text message to enable said TTS to aurally present the identity.

11. A mobile telephone as claimed in claim 9 or 10, further comprising a music decoder coupled to said semiconductor chip for enabling said control means to determine whether music is playing and for starting and stopping said music.

12. A mobile telephone as claimed in claim 9, further comprising an alert means coupled to control means for enabling said control means to command an alert to be issued.

13. A mobile telephone as claimed in claim 12, in which said alert means comprises a mechanical vibrator and/or a tone generator.

14. A mobile telephone as claimed in claim 9, further comprising a stereo amplifier coupled to said control means for enabling said control means to control the volume being output by the stereo amplifier.

15. A semiconductor chip substantially as hereinbefore described and with reference either FIG. 1 or 2.

16. A method of aurally presenting a notification or text message substantially as hereinbefore described and with reference to either FIG. 1 or 2.

17. A mobile telephone substantially as hereinbefore described and with reference to any one of FIGS. 1 to 3.
